(19) United States
(12) Patent Application Publication
(10) Pub. No.: US 2021/0184291 A1
(43) Pub. Date: Jun. 17, 2021

(54) HEAT TRANSFER DEVICE

(71) Applicant: Miba eMobility GmbH, Laakirchen (AT)

(72) Inventors: Stefan GAIGG, Gmunden (AT); Martin LIEBL, Altmuenster (AT); Franz POEHN, Pettenbach (AT)

(73) Assignee: Miba eMobility GmbH, Laakirchen (AT)

(21) Appl. No.: 17/269,030

(22) PCT Filed: Aug. 27, 2019
(86) PCT No.: PCT/AT2019/060273

§ 371 Date: Feb. 17, 2021

(30) Foreign Application Priority Data
Aug. 29, 2018 (AT) A50737/2018

(51) Int. Cl. H01M 10/6552; F28D 15/02; F28D 15/04; H01M 10/613; H01M 10/6556

(52) U.S. Cl. CPC H01M 10/6552; F28D 15/0283; F28D 15/046; H01M 10/6556; F28D 15/0233; H01M 10/613; F28D 15/0275

(57) ABSTRACT

The invention relates to a heat transfer device (1) having a sleeve (4) closed on all sides, wherein the sleeve (4) defines a volume in which one insert element (3) or multiple insert elements (3) made of a sintered material is/are arranged to form at least one heat pipe, wherein at least one channel (2) for a heat transfer medium is formed in the sintered material, and the sleeve (4) is at least partially formed from a single-layer or multi-layer film (5, 6).

The invention relates to a heat transfer device with a sleeve, i.e. a cover, closed on all sides, wherein the sleeve defines a volume in which one insert element or multiple insert elements made of a sintered material is/are arranged to form at least one heat pipe, wherein at least one channel for a heat transfer medium is formed in the sintered material.

The invention further relates to a rechargeable battery having at least one storage module for electrical energy and at least one heat transfer device for cooling or controlling the temperature for the at least one storage module.

The invention further relates to a method for producing a heat transfer device comprising the steps: providing one insert element or multiple insert elements made of a sintered material and arranging the insert element or the insert elements in a sleeve which defines a volume.

The service life and effectiveness as well as the safety of a rechargeable battery for e-mobility depend, among other factors, on the temperature during operation. For this reason, various concepts have been suggested for the cooling and/or temperature control of the rechargeable batteries. These concepts can be divided into essentially two types, namely air cooling and water cooling and/or in general cooling with liquids.

For water cooling, cooling bodies in which at least one coolant channel is formed are used. These cooling bodies are arranged between the individual modules of the rechargeable battery or on the modules. In this regard, a module is an individual unity of the rechargeable battery, i.e. not obligatorily just a cell.

It is further known from the prior art that so-called heat pipes are used for heat transfer.

DE10 2008 054 958 A1 describes a temperature control system for controlling the temperature of at least one rechargeable battery of a vehicle with at least one heat transfer device for thermal connection of the battery to at least one heat source and/or heat sink arranged in the vehicle. The heat transfer device comprises at least one heat contact zone for releasably thermally contacting the battery and at least one heat pipe for heat transfer.

In simple terms, a heat pipe is a self-contained system in a (substantially pipe-shaped) housing that has a fluid in its inside that is close to its boiling point at operating temperature due to the prevailing pressure. If the heat pipe is heated in a partial area, the fluid changes to the gaseous phase, to flow in the direction of a cooler area in the interior of the heat pipe, condense there and flow back into the warmer area along the inner walls of the housing of the heat pipe. In the course of this (heat) transport process, the heat pipe extracts heat from its surroundings in an evaporation area and supplies this heat to the surroundings of the condensation area of the heat pipe.

The present invention is based on the object of creating an improved system for cooling a rechargeable battery, i.e. an accumulator.

The object is achieved in the initially mentioned heat transfer device in that the sleeve is at least partially formed from a single-layer or multi-layer film, i.e. foil.

The object is further achieved by means of the initially mentioned rechargeable battery in which the heat transfer device is provided in accordance with the invention.

The object is further achieved by the initially mentioned method according to which it is provided that at least one single-layer or multi-layer film is used as the sleeve, and the insert element is enclosed on all sides by the at least one film.

The advantage of this is that compared to direct liquid cooling, by the use of a heat transfer device a design of the rechargeable battery is possible in which no liquid is present in direct proximity of the rechargeable battery. Moreover, by the connection of the rechargeable battery to the region of the heat transfer device with the vaporized heat transfer medium, a relatively high degree of constant temperature can be achieved over the entire area of the rechargeable battery to be cooled. Moreover, the design of the sleeve as a film, as compared to known heat pipe systems, allows for easier mounting on the heat transfer device on the component to be cooled and/or temperature-controlled, since soldered connections etc. can be dispensed with. A further advantage of the heat transfer device can be seen in that no electrochemical reactions between the materials of the heat transfer device, i.e. the material of the sleeve and the material of the insert element, are to be expected in the operating state. This, in turn, results in a higher safety of the heat transfer device and/or of its application in a rechargeable battery. Moreover, as compared to known heat pipe systems, the heat transfer device can be produced at lower costs.

According to an embodiment variant of the heat transfer device, to improve the temperature constancy across the surface to be cooled and/or temperature-controlled, it may be provided that in the at least one insert element multiple channels for multiple heat pipes are formed.

According to a further embodiment variant of the invention, it may be provided that at least individual ones of the channels are formed so as to be adjustable relative to the other channels. Hence, better adaption of the heat transfer device to a not entirely plane surface and/or a better tolerance compensation with the heat transfer device can be achieved, even where no so-called gap filler is used.

Preferably, the at least one insert element is formed as a single piece, with which not only the production of the heat transfer device can be simplified, but with which its stability can also be improved, whereby the heat transfer device can be designed thinner.

According to a further embodiment variant of the invention it may be provided that the sintered material is formed by glass. Hence, a relatively light material may be used which is also inert with regard to the material and chemicals used. Moreover, glass is usually harmless to the environment.

To improve the capillary action of the at least one insert element, according to an embodiment variant of the invention, it may be provided that the sintered material is formed of particles with a grain size in a range of 100 μm to 500 μm.

According to another embodiment variant of the invention, the channels can at least partially be formed having an arcuate cross section, whereby the stability of the channels may be improved. With the embodiment variant it is also possible to design the heat transfer device thinner.

To homogenize the pressure conditions and/or temperature conditions in the heat transfer device, according to another embodiment variant of the invention it may be provided that at least individual ones of the channels are connected to one another via cross channels. As a further consequence, a homogenization of the temperature of the storage cells can be achieved at least in the area of the contact surface with the heat transfer device.

According to an embodiment variant of the invention, an improvement of the capillary action of the at least one insert element may be achieved where a liquid-absorbing element is arranged to adjoin the at least one insert element.

To reduce the required installation space of a rechargeable battery equipped with the heat transfer device, it may be provided that the at least one insert element comprises a deflection at an end region. This deflection can thus serve for connection of the heat transfer device to a cooling device, such that with the deflection a different or structurally more favorable connection can be geometrically realized with the deflection.

To improve the observation of the correct functioning of a rechargeable battery, which is equipped with the heat transfer device, according to a further embodiment variant of the invention, it may be provided that at least one sensor element and/or a conducting path is arranged on the sleeve of the heat transfer device.

Easier loading of the at least one insert element with the heat transfer medium may be achieved if, according to an embodiment variant of the invention, the insert element is provided with a liquid prior to arrangement in the sleeve.

Moreover, to simplify the establishment of the operational readiness of the heat transfer device, according to an embodiment variant of the invention, it may be provided that the at least one film is provided having a lateral projection, wherein in the projection at least one opening is arranged via which the volume of the sleeve is evacuated after insertion of the at least one insert element.

For the purpose of better understanding of the invention, it will be elucidated in more detail by means of the figures below.

These show in a simplified schematic representation:

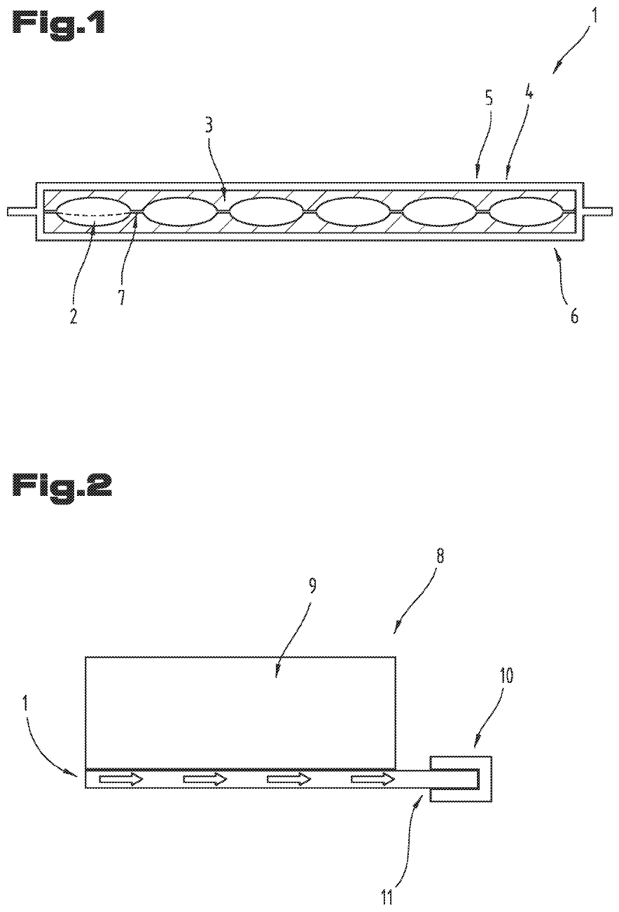

FIG. 1 a heat transfer device in a sectional front view;

FIG. 2 a rechargeable battery with a heat transfer device;

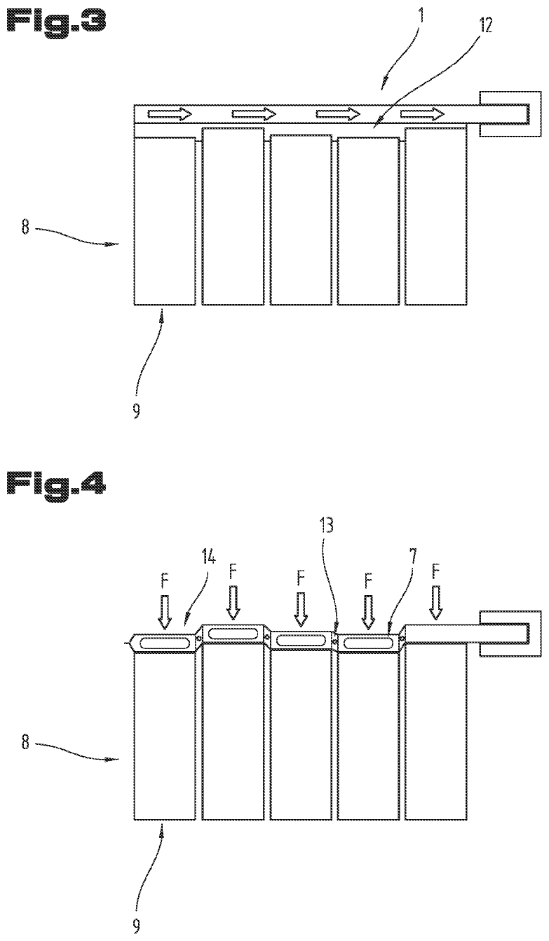

FIG. 3 an embodiment variant of the connection of the heat transfer device to the storage modules of the rechargeable battery;

FIG. 4 another embodiment variant of the connection of the heat transfer device to the storage modules of the rechargeable battery;

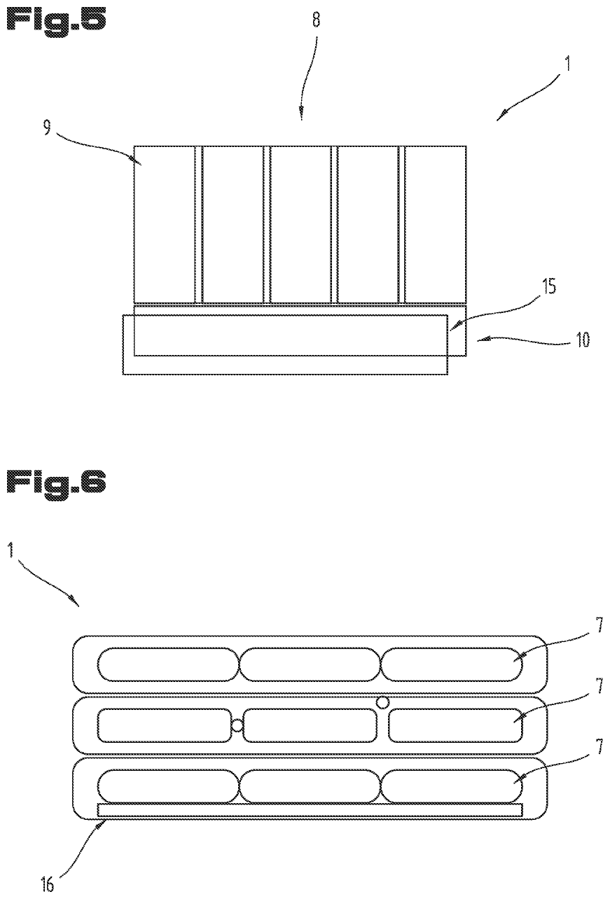

FIG. 5 an embodiment variant of the connection of the heat transfer device to a cooling device;

FIG. 6 different designs of the channels of the heat transfer device;

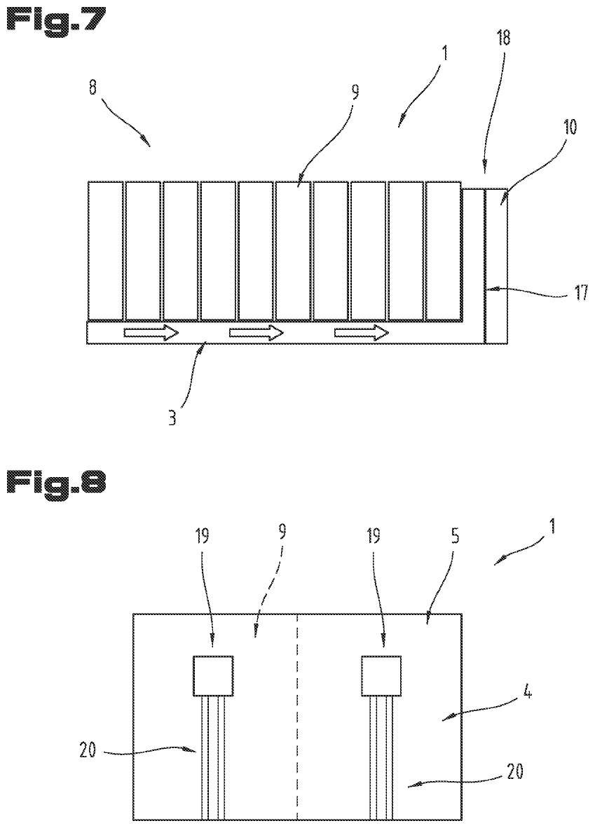

FIG. 7 an embodiment variant of the heat transfer device in a front view;

FIG. 8 an embodiment variant of the heat transfer device in a top view;

FIG. 9 a method step for producing the heat transfer device;

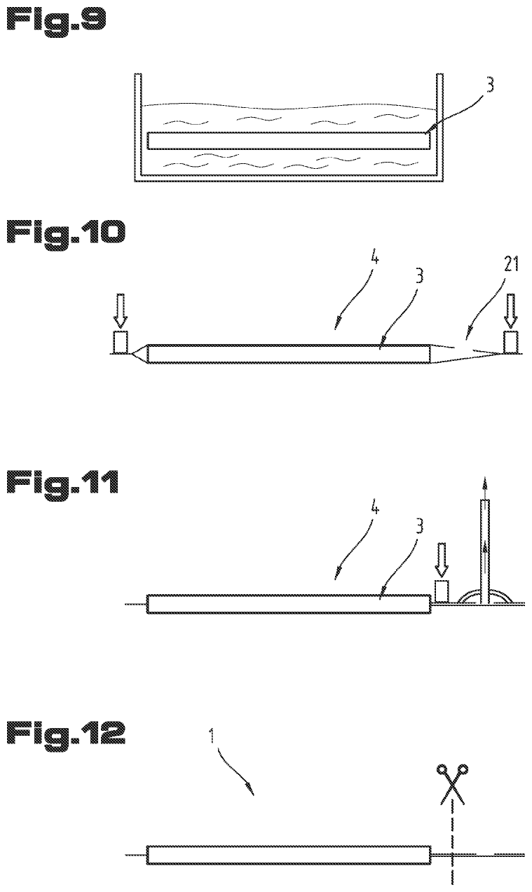

FIG. 10 a further method step for producing the heat transfer device;

FIG. 11 a further method step for producing the heat transfer device;

FIG. 12 a further method step for producing the heat transfer device.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a first embodiment variant of a heat transfer device 1 shown in a sectional front view. The heat transfer device 1 is preferably designed as a flat module. In this context, a flat module refers to a heat transfer device 1 in which preferably multiple channels 2 for a heat transfer medium are arranged, in particular next to one another. However, it is also possible that the heat transfer device 1 merely comprises one channel 2.

The flat module may for example have a thickness 7 of between 0.3 mm and 3 mm, a width 8 of 300 times the thickness 7 to 3000 times the thickness 7 and a length 9 of 1 time the width 8 to 10 times the width 8.

A liquid, which—as is common for heat pipes—is vaporized for heat transfer in the heat transfer device 1 and hence takes over the heat transfer in the channels 2, is used as the heat transfer medium.

For example water, methanol etc. can be used as liquid.

The at least one channel 2 is arranged and/or formed in an insert element 3. The insert element 3 is enclosed by a sleeve 4 on all sides. The sleeve 4 is designed to be closed on all sides. The sleeve 4 further defines a volume for the insert element 3. This volume of the sleeve 4 is preferably of equal size as the volume which the insert element 3 has. Thus, the sleeve 4 preferably lies against the insert element 3 over its entire surface on all sides. However, the volume of the sleeve 4 may also be larger than the volume of the insert element 3, preferably by a maximum of 20%, in particular by a maximum of 10%, larger.

The insert element 3 consists of a sintered material. The sintered material in particular is a capillary material, i.e. a material having capillaries. For example, the sintered material may consist of a metal, such as copper or aluminum and/or alloys thereof. According to a preferred embodiment variant of the heat transfer device 1 the sintered material consists of glass.

However, in general, other suitable sintering materials may be used as well.

The insert element 3 is produced by the particles of the sintering material being sintered with one another. For this purpose, the sintering material is inserted into a corresponding mold, which preferably already corresponds to the shape of the insert element 3. However, the insert element 3 may also be post-processed (machined) after sintering.

The sintering itself is carried out according to the state of the art for powder metallurgy.

According to a preferred embodiment variant, particles of the sintering material which have a grain size from a range of 100 μm to 500 μm, in particular from a range of 150 μm to 300 μm, are used for producing the insert element 3. The grain size determination is carried out using microsections as is per se known.

The at least one channel 2 may be already taken into consideration when shaping the insert element 3 or it may be incorporated into the insert element 3 later, in particular after sintering. Machining of the green compact of the insert element 3 to form the at least one channel 2 is also possible.

The insert element 3 may also be designed to have multiple parts. For example, the insert element 3 may form a separate component for each channel 2. In addition or alternatively to this, the insert element 3 may also be formed of an upper part and a bottom part, wherein the separating plane may be formed in the region of the channel 2 or the channels 2, so as to be able to form it/them more easily. In particular, the separating plane can be located on half the channel height (in cross section as seen in FIG. 1).

The individual parts of the insert element 3 can be arranged loosely against each other in the heat transfer device 1. Preferably, however, they are connected to each other.

However, it is also possible for the insert element 3 to be formed in one piece in accordance with another preferred embodiment variant.

The sleeve 4 is at least partially formed from a single-layer or multi-layer film. Preferably, the entire sleeve 4 consists of at least one multi-layer film. If merely one film is used, it is folded once to form a kind of “pocket”. The remaining, open edge regions are then closed by connecting the two film parts to one another.

However, it is also possible that the sleeve 4 is formed of a first single-layer or multi-layer film 5 and a further single-layer or multi-layer film 6, wherein the two films 5, 6 are connected to one another on all sides to form the aforementioned, entirely closed volume for the insert element 3.

The connection of the two films 5, 6 or the two film parts to one another may be established by bonding. Preferably, however, they are welded together. For example, temperature pulse welding, laser welding, IR welding, ultrasonic welding, high-frequency welding can be used as welding methods.

The first film 5 and/or the further film 6 consists/consist of a laminate comprising a first plastic film layer, an enforcement layer connected thereto, at least one metal film layer connected to the enforcement layer or a metalized further plastic film layer connected to the enforcement layer.

The first film 5 and/or the further film 6 may also consist of a laminate, which comprises a first plastic film layer, at least one metal film layer, at least one metalized further plastic film layer and, between the plastic film layer and a metal film insert, an abrasion-proof layer, for example of PET. Further plastic material layers may be arranged between the layers.

The first plastic insert may in general be a “welding layer” for welding the first film 5 to the further film 6.

Moreover, in general, one or multiple metal film layers can be used to influence or improve the tightness of the sleeve 4.

In general, other laminates can be used as well. For example, merely the first film 5 can be provided with the metal film layer or merely the further film 6 can be provided with the metal film layer. Likewise, merely the first film 5 can comprise the enforcement layer or merely the further film 6 can comprise the enforcement layer. Likewise, structures of the first film 5 and/or the further film 6 with more than three layers are possible. However, preferably, the first film 5 and the further film 6 are designed equally.

The enforcement layer and/or the metal film layer of the further film 6 can differ from the enforcement layer and/or the metal film layer of the first film 5. However, preferably, the two enforcement layers and/or the two metal film layers are designed equally.

The two films 5, 6 are arranged such that the two plastic film layers lie against one another and are connected to one another via these plastic film layers. If the further film 6 comprises (merely) the second plastic film layer, said second plastic film layer is arranged directly adjacent to the plastic film layer of the first film 5 and connected thereto.

Instead of a metal film layer, a metalized further plastic film layer can also be used, while in this case the metalization is preferably arranged between the enforcement layer and the further plastic film layer.

The first plastic film layer and/or the second plastic film layer and/or the metalized further plastic film layer preferably consists/consist to at least 80 wt. %, in particular at least 90 wt. %, of a thermoplastic material or of an elastomer. The thermoplastic material can be selected from a group comprising and/or consisting of polyethylene (PE), polyoxymethylene (POM), polyamide (PA), in particular PA 6, PA 66, PA 11, PA 12, PA 610, PA 612, polyphenylene sulphide (PPS), polyethylene terephthalate (PET), crosslinked polyolefins, preferably polypropylene (PP). The elastomer can be selected from a group comprising and/or consisting of thermoplastic elastomers such as thermoplastic vulcanizates, olefin-, amine-, ester-based thermoplastic polyurethanes, in particular ether-based/ester-based thermoplastic elastomers, styrene block copolymers, silicone elastomers.

At this point, it should be noted that the term plastic material is understood as a synthetic or natural polymer produced from corresponding monomers.

Preferably, the first plastic film layer and/or the second plastic film layer and/or the metalized further plastic film layer consists/consist of a so-called sealing film. This has the advantage that the respective films 5, 6 can be connected to one another directly.

However, it is also possible to use other plastic materials, such as thermosetting plastic materials and/or thermosetting materials, which are then for example adhered to one another by means of an adhesive. Two-part adhesive systems based on polyurethane or silicone or hot melt adhesive systems are particularly suitable for this purpose.

Preferably, the enforcement layer(s) comprise/comprises a or consist/consists of a fiber reinforcement. However, the enforcement layer(s) can also consist of another material, such as a plastic film, which consists of a plastic material differing from the plastic material of the first plastic film layer and/or the second plastic film layer and/or the metalized further plastic film layer.

The fiber reinforcement is preferably formed as a separate layer which is arranged between the plastic film layer and the metal film layer or the metalized further plastic film layer. If cavities are formed in the fiber reinforcement, these can also be at least partially filled with the plastic material of the plastic film layer or the metalized further plastic film layer.

The fiber reinforcement can be formed of fibers and/or threads, which are selected from a group comprising or consisting of glass fibers, aramid fibers, carbon fibers, mineral fibers such as basalt fibers, natural fibers such as hemp, sisal and combinations thereof.

Preferably, glass fibers are used as fiber reinforcement. The proportion of the fibers, in particular the glass fibers, in the fiber reinforcement can amount to at least 80 wt. %, in particular at least 90 wt. %. Preferably, the fibers and/or threads of the fiber reinforcement consist merely of glass fibers.

The fibers and/or threads can be present in the fiber reinforcement as roving, for example as a non-woven fabric. However, preferably the fibers and/or threads become a woven fabric or a knitted fabric. In this regard, it is also possible that the woven or knitted fabric is merely present in some regions and that the remaining regions of the fiber reinforcement are formed by a roving.

It is also possible that rubberized fibers and/or threads are used as or for the fiber reinforcement.

When using a woven fabric, different types of weaves are possible, in particular plain, twill or satin weave. Preferably, a plain weave is used.

However, it is also possible to use an open-mesh glass fabric or glass roving.

The fiber reinforcement can be formed as a single layer. However, it is also possible that the fiber reinforcement comprises several, optionally separate, individual layers, for example two or three, wherein at least individual or several individual layers can at least in some regions, preferably entirely, consist of fibers and/or threads different as compared to the rest of the individual layers.

In the alternative or in addition to the fiber reinforcement, the enforcement layer(s) 13, 16 can comprise a mineral filling. For example, calcium carbonate, talc, quartz, wollastonite, kaolin or mica can be used as a mineral filling (mineral filler material).

The metal film layer in particular is an aluminum film. However, other materials such as copper or silver can also be used.

The metal film layer can have a layer thickness of between 5 μm and 100 μm.

In case of the use of the metalized further plastic film layer, the mentioned metals can be used for the metalization. Preferably, the metalization has a layer thickness selected from a range of between 5 nm and 100 nm. The metal vapor deposition of the further plastic film layer can be carried out by means of a method known from the prior art.

The plastic film layer of the first and/or further film 5, 6 and/or the further plastic film layer of the first and/or further film 5, 6, which comprises the metalization, can have a layer thickness of between 10 μm and 200 μm.

The layer thickness of the enforcement layer(s) can amount to between 5 μm and 50 μm.

The first film 5 and/or the further film 6 can in particular comprise the following structure in the indicated order:
plastic film layer of PP or PE;
enforcement layer of a glass fiber fabric;
metal film layer of aluminum with a layer thickness of 20 μm (in case of multiple metal film layers, the layer thickness of the individual metal film layer may be reduced, for example to 10 μm).

In case of the further film 6 consisting merely of the plastic film layer, preferably a polyethylene terephthalate (PET) is used as the plastic material for it.

The first film 5 and/or the further film 6 can also comprise at least one further layer, such as at least one further enforcement layer and/or at least one primer layer and/or at least one thermotropic layer.

Although the first film 5 and the further film 6, if it also is a film laminate, can in general be used in the form of individual films for producing the heat transfer device 1, such that the film laminate(s) are only formed in the course of the production of the heat transfer device 1, it is advantageous if the first film 5 and/or the further film 6 are used as a (laminated) semi-finished product.

For connecting the individual layers of the laminate or the laminates, these can be adhered to one another by means of adhesives. The aforementioned adhesives are suitable for this purpose. Besides adhesives, coextrusion and extrusion coating can also be used as joining options. Of course, a combination is also possible in which several plastic materials are coextruded and adhesively laminated to one another with an extrusion-coated metal or (fiber) enforcement layer. In general, all known methods can be used for producing composite films and/or film laminates.

A fiber layer, for example of a paper, can be arranged between the plastic film layer of the first film 5 and the plastic film layer of the further film 6. This fiber layer is equipped to be liquid-resistant. A coating may be provided for this purpose. However, it is also possible that the fibers of the paper and/or of the fiber layer are per se designed to be liquid proof, for example coated. The coating can also provide the sleeve 2 with greater strength and/or rigidity. The coating may, for example, be a cured adhesive layer.

According to another embodiment variant of the heat transfer device 1, which is also shown in FIG. 1, it may be provided that at least individual ones of the channels 2 are connected to each other via cross channels 7. Preferably, all of the channels 2 are provided with these cross channels 7, so that all of the channels 2 are thus connected to one another.

The term “cross channel” refers to the fact that the cross channels 7 run transversely to the heat transport direction. In FIG. 1, the heat transfer direction in the channels 2 is perpendicular to the display plane (paper plane).

The cross-sectional area of the channels 2 (viewed in the heat transfer direction) can be between 1 time to 50 times larger than that of the cross channels 7. However, the cross channels 7 may also have a cross-sectional area as large as that of the channels 2.

As stated above, the heat transfer device 1 may be used for cooling and/or controlling the temperature of a rechargeable battery 8, i.e. an accumulator, as is schematically shown in FIG. 2. However, it should be noted that the heat transfer device 1 may also be used for cooling and/or controlling the temperature of an electronic component, in particular a (high) power electronic component, especially in the automotive field, such as an IGBT, a stationary accumulator, in an industrial plant cooling of surfaces, fuses, etc. Thus, the statements in the present description analogously apply to these applications.

The rechargeable battery 8 comprises at least one storage module 9, in particular multiple storage modules 9 for electrical energy. For example, the rechargeable battery 8 may comprise between 2 and 50 storage modules 9, which can in particular be distributed onto multiple rows. The mentioned values for the number of storage module 9 is not to be understood being restrictive.

As the basic construction of such rechargeable batteries 8 for e-mobility is known from the prior art, reference is made thereto so as to avoid repetitions.

In the embodiment variant of the rechargeable battery 8 shown in FIG. 2, the heat transfer device 1 is arranged below the at least one storage module 9. However, the heat transfer device 1 may also be arranged at another location on the rechargeable battery 8, for example above the at least one storage module 9, as shown in FIG. 3, or laterally of the at least one storage module 2. Combinations thereof are also possible, so that the heat transfer device 1 is arranged, for example, below and to the side of the at least one storage module 9.

Preferably, just one single heat transfer device 1, which covers at least the entire bottom surface or top surface of the rechargeable battery 8, is provided in the rechargeable battery 8 for all storage module 9. However, it is also possible that the overall number of storage modules 9 is distributed across multiple heat transfer device 1, wherein these multiple heat transfer devices 1 are preferably each assigned to multiple storage modules 9. The rechargeable battery 8 may thus comprise one or multiple heat transfer devices 1.

The heat that was generated in the rechargeable battery 8 is transported away via the at least one heat transfer device 1. To discharge the heat from the region of the rechargeable battery 8, the heat transfer device 1 may be connected to a cooling device, for example the air conditioner of a vehicle. For this purpose, the heat transfer device 1 may have a cooling interface 10. Said cooling interface 10 may for example be formed in a side region 11 of the heat transfer device 1. Said side region is in particular not covered by a storage module 9. The cooling interface 10 may also be referred to as cooling interface lug.

Cooling of the heat transfer medium in the channels 7 may be carried out in the cooling interface 10 for example using a coolant or a vaporizing cryogen.

As shown in FIG. 3, according to an embodiment variant of the rechargeable battery 8, it is possible that between the heat transfer device 1 and the at least one storage module 9, a leveling compound 12 is arranged at least in some sections, wherein the leveling compound 12 directly, i.e. immediately, rests on both the heat transfer device 1 and the at least one storage module 9. Hence, it is possible to compensate for tolerances regarding the size of the storage modules 9 and thus improve the heat transfer from the storage modules into the heat transfer device 1, in particular where the heat transfer device 1 is designed to be rigid. The leveling compound may be formed in accordance with the prior art for such gap fillers. According to another embodiment variant of the heat transfer device 1, as opposed to this, it may be provided that at least individual ones of the channels 2, in particular all channels 2, are formed so as to be adjustable relative to the other channels 7, as is shown in FIG. 4. For this purpose, the insert element 3 may be designed having multiple parts, in particular comprise at least one separate component for each channel 2. These components may be connected to one another in an articulated manner. It is also possible to arrange rolling elements 13, for example having a cylinder shape or a spherical shape, between the components.

As can be seen from FIG. 4, the heat transfer device 1 may comprise one insert element part 14, which, in particular directly, rests against the respective storage module 9, per storage module 9. By the relatively displaceable arrangement of the insert element parts 14 to one another (i.e. the non-rigid design of the insert element 3), it is possible to compensate for tolerances between the storage modules 9 and to thus dispense with the leveling compound 12 (FIG. 3). The insert element parts 14 may be connected, in particular bonded, to the respective, assigned storage module 9.

To improve heat transfer from the heat transfer device 1 to the cooling device in the cooling interface 10, the heat transfer device 1 may comprise a separate connecting element 15, as in particular shown by FIG. 5 which shows a rechargeable battery 8 in a top view. The heat transfer device 1 is arranged on top of the storage modules 9. The connecting element may for example be designed as a sintered component and may in particular be designed as a strip-shaped insert part. This insert part is arranged between the coolant ducts of the cooling device and allows for a planar connection of the heat transfer device 1 in this region.

FIG. 6 shows different embodiment variants of cross sectional shapes of the channels 2 of the heat transfer device 1. For example, the channels can have a rectangular or square cross-sectional shape. The edges (i.e. the side edges of the channels 2) are preferably rounded.

However, according to a preferred embodiment variant of the heat transfer device 1, the channels 2 are designed at least partially arcuate, meaning that they have an arcuate cross section at least in some sections. For example, the channels 2 can be designed at least approximately with an oval or elliptical cross-section, as shown in FIG. 1. However, it is also possible that only the side of the channels 2 of the heat transfer device 1 adjacent to the storage modules is arcuate, and the channels 2 have an at least approximately flat bottom, as indicated by dashed lines in FIG. 1.

FIG. 6 shows yet another embodiment variant heat transfer device 1. It may be provided that in order to support the capillary action of the insert element 4, a liquid-absorbing element 16 is arranged to rest thereon. Said element 16 may for example be a paper element (of the kind of a blotting paper) or a sponge element.

If multiple heat transfer devices 1 are provided or if multiple separate insert elements 3 are provided in the heat transfer device, the liquid-absorbing element 16 may also be arranged between two heat transfer devices 1 and/or between two insert elements 3.

Moreover, it is possible that more than one liquid-absorbing element 16 is provided in the heat transfer device 1.

Preferably, the liquid-absorbing element 16 is bendable and compressible to allow for tolerances to be compensated for.

FIG. 7 shows a further embodiment variant of the heat transfer device 1 in a side view.

It should be noted at this point that in the figures, equal reference numbers and/or component designations are used for equal parts. Therefore, the explanations regarding the individual parts apply to all embodiment variants of the invention, unless it is otherwise indicated, or the non-applicability is obvious anyway.

In the heat transfer device 1 according to FIG. 7, the insert element 3 is provided with a deflection 18 in an end region 17. The heat transfer device 1 therefore has two legs arranged at an angle to each other, wherein the angle is unequal to 180°. In particular, the angle is selected from a range of 60° to 120°. Preferably, the angle amounts to 90°.

By this deflection 18, the heat transfer device 1 may rest against at least one of the storage cells 9 of the rechargeable battery 8 on two sides. Moreover, this provides the advantage that the cooling interface 10 may be displaced in terms of location.

According to a further embodiment variant of the heat transfer device 1, which is shown in FIG. 8, it may be provided that at least one sensor element 19 and/or at least one conducting path 20 is arranged, in particular imprinted, on the sleeve 4. Preferably, at least one sensor element 19 is assigned to each storage module 9 (or each cell of the storage module 9, since the storage modules 9 may also have multiple cells for storing electrical energy).

In general, the sensor element 19 can have any desired shape and be arranged at any suitable position of the heat transfer device 1. However, in the preferred embodiment variant, the at least one sensor element 19 is arranged on or in the single-layer or multi-layer first film 5 and/or the single-layer or multi-layer further film 6 (both shown in FIG. 1). If the sensor element 19 is arranged in the first film 5 and/or in the further film 6, it may be arranged between two of the aforementioned layers of the laminate in the first film 5 and/or in the further film 6. However, it is also possible that the at least one sensor element 19 is arranged merely within one layer of the laminate. For this purpose, the sensor element 19 can already be provided during the formation of the layer and be enclosed by and/or embedded in the material of this layer.

“Arranged on the film” means that the at least one sensor element 19 is arranged on an outside, i.e. on an outer surface, of the single-layer or multi-layer film 5 and/or 6.

It is further preferred for the at least one sensor element 19 to be a thin layer sensor element. Thin film technology is per se known from the relevant literature, such that reference is made thereto regarding details.

It is also possible that the sensor element 19 is applied on the single-layer or multi-layer film 4 as a (partial) coating. The coating can in particular be applied by means of a printing process (e.g. screen printing, web-fed printing, ink jet printing, engraving, gravure printing, flat printing, stamp printing), by spraying, vapor deposition, plasma coating, sputtering, powder coating, etc.

Moreover, it is possible that the at least one sensor element 19 is contacted by wire. However, the electrical contact of the at least one sensor element 19 by means of conducting paths 20, as can be seen from FIG. 8, is preferred. The conducting paths 20 are in particular arranged on the same surface of the single-layer or multi-layer film 5 and/or 6 on which the at least sensor element 19 is arranged as well.

Moreover, the conducting paths 20 are preferably applied by means of thin film technology or by means of a coating method. In this regard, reference is made to the corresponding explanations above regarding the sensor element 19.

It should be noted that another element may also be contacted to the conducting path 20 such that a sensor element 19 does not obligatorily have to be present and more than one conducting path 20 does not obligatorily have to be arranged.

If the at least one sensor element 19 is arranged on an outer side of the single-layer or multi-layer film 4, this is preferably the surface of the film 5 or the further film 6 with which it rests against the storage modules 9, so that the at least one sensor element 19 also rests directly against the at least one cell 3.

The sensor element 19 can be formed as desired. In the preferred embodiment variant of the heat transfer device 1, however, at least one temperature sensor and/or at least one pressure sensor is used.

The at least one temperature sensor can for example be a thermocouple or a thermistor. In general, other suitable temperature sensors can be used as well.

The temperature sensor can comprise a negative temperature coefficient thermistor (NTC) or a positive temperature coefficient thermistor (PTC).

A piezoelectric sensor, a piezoresistive sensor, a capacitive pressure sensor, etc. can be used as force or pressure sensor.

The sensor element 19 can also be a humidity sensor or a leak sensor or a pressure-drop sensor.

Since the sensors per se are known from measurement technology, these and the underlying measurement principles are not explained in further detail.

The storage modules 9 of the rechargeable battery 8 and/or optionally the cells of the storage modules 9 may be designed to be cuboidal, cylindrical and arranged to be lying or standing. In other words, the specific embodiment of the storage modules 9 is not to be considered restrictive.

The heat transfer device 1 can for example be mounted to the rechargeable battery 8 by means of clamps. However, other fastenings, for example by means of pins or rivets, etc., are also possible.

FIGS. 9 to 12 show a preferred method for producing the heat transfer device 1 in a simplified manner. The preferred method comprises all of the shown steps, in particular in the indicated order.

After provision of the insert element 3, which—as stated above—is produced as a sintered component by means of powder-metallurgical methods, it is provided with the heat transfer medium in a first step, as shown in FIG. 9. For this purpose, the insert element 3 may in particular be soaked in a bath of this heat transfer medium. However, the heat transfer medium may also be applied to the insert element 3 in another way, for example by spraying etc. Moreover, it is in general possible that the heat transfer medium is inserted into the insert element 3 at a later point in time, for example after it has been arranged in the sleeve 4.

According to the preferably carried-out soaking, the insert element 3 is provided with the sleeve 4. For this purpose, the first film 5 and preferably the further film 6 are used in a corresponding size or cut to a corresponding size. The insert element 3 is arranged between film parts of the first film 5 or between the first and the further film 5, 6, as is shown in FIG. 10. Then, the volume, which the sleeve 4 defines, is evacuated via a corresponding opening 21 in the first film 5 or in the further film 6. To form the opening 21, the sleeve 2 is provided having an excess on one side.

In the next step, the sleeve 4 is entirely closed by the first film 5 or the first film 5 preferably being welded to the further film 6, as is shown in FIG. 11. If the first film 5 is being connected to the further film 6, these two can be held together mechanically before joining, for example by means of clamps, etc.

Lastly, the heat transfer device 1 is cut to the specific measure, i.e. the excess is removed. This is shown in FIG. 12.

The production of the heat transfer device 1 may also be carried out as follows. The sintering powder (sinter powder) is filled into a mold (matrix), in particular made of graphite. To keep the channel 2 or the channels 2 open during sintering, a rod may be inserted into the sintering powder or the rod may be arranged in the mold already before filling in the sintering powder.

The rod is in particular made of a refractory and has the cross-sectional shape of the channel 2 or the channels 2. After sintering, the thus produced insert element 3 is inserted into the sleeve 4 and welded. The sleeve 4 may thus be produced from the two films 5, 6. Likewise, the sleeve 4 may also be formed as an (endless) tube. During welding, one side remains open in order to provide the insert element with the heat transfer medium, in particular the liquid.

After this, the semi-finished heat transfer device 1 is evacuated and lastly the still open side is welded.

In general, the heat transfer device 1 may have a circular, oval, quadrangular, in particular rectangular cross section (as seen in the direction of heat transfer). However, other special shapes, such as at least approximately cross-shaped or star-shaped, are also possible.

Furthermore, in general, one insert element 3 or, in general, multiple insert elements 3 may be arranged in the sleeve 4. The above explanations with just one insert element 3 are therefore not to be understood in a limiting way.

The exemplary embodiments show and/or describe possible embodiment variants of the invention, while it should be noted at this point that combinations of the individual embodiment variants are also possible.

Finally, as a matter of form, it should be noted that for ease of understanding of the structure, the heat transfer device 1 and the rechargeable battery 8 are not obligatorily depicted to scale.

### LIST OF REFERENCE NUMBERS

1 heat transfer device
2 channel
3 insert element
4 sleeve
5 film
6 film
7 cross channel
8 rechargeable battery
9 storage module
10 cooling interface
11 region
12 leveling compound
13 rolling element
14 insert element part
15 connecting element
16 element
17 end region
18 deflection
19 sensor element
20 conducting path
21 opening

1. A heat transfer device (1) having a sleeve (4) closed on all sides, wherein the sleeve (4) defines a volume in which one insert element (3) or multiple insert elements (3) made of a sintered material is/are arranged to form at least one heat pipe, wherein at least one channel (2) for a heat transfer medium is formed in the sintered material, wherein the sleeve (4) is at least partially formed from a single-layer or multi-layer film (5, 6).

2. The heat transfer device (1) according to claim 1, wherein multiple channels (2) for multiple heat pipes are formed in the at least one insert element (3).

3. The heat transfer device (1) according to claim 2, wherein at least individual ones of the channels (2) are formed so as to be adjustable relative to the other channels (2).

4. The heat transfer device (1) according to claim 1, wherein the at least one insert element (3) is formed in one piece.

5. The heat transfer device (1) according to claim 1, wherein the sintered material is formed by glass.

6. The heat transfer device (1) according to claim 1, wherein the sintered material is formed of particles having a grain size in a range of 100 μm to 500 μm.

7. The heat transfer device (1) according to claim 2, wherein the channels (2) are formed to at least partially have an arcuate cross section.

8. The heat transfer device (1) according to claim 2, wherein at least individual ones of the channels (2) are connected to each other via cross channels (7).

9. The heat transfer device (1) according to claim 1, wherein a liquid-absorbing element (16) adjoins the at least one insert element (3).

10. The heat transfer device (1) according to claim 1, wherein the at least one insert element (3) comprises a deflection (18) at an end region (17).

11. The heat transfer device (1) according to claim 1, wherein at least one sensor element (19) and/or at least one conducting path (20) is arranged, in particular imprinted, on the sleeve (4).

12. A rechargeable battery (8) having at least one storage module (9) for electrical energy and at least one heat transfer device (1) for cooling or controlling the temperature of the at least one storage module (9), wherein the heat transfer device (1) is designed according to claim 1.

13. A method for producing a heat transfer device (1) comprising the steps:
providing one insert element (3) or multiple insert elements (3) made of a sintered material and
arranging the insert element (3) or the insert elements (3) in a sleeve (4) which defines a volume,
wherein at least one single-layer or multi-layer film (5, 6) is used as the sleeve (4), and the insert element (3) or the insert elements (3) is/are enclosed on all sides by the at least one film (5, 6).

14. The method according to claim 13, wherein the at least one insert element (3) is provided with a liquid, in particular soaked in the liquid, prior to arrangement in the sleeve (4).

15. The method according to claim 13, wherein the at least one film (5, 6) is provided with a lateral projection, wherein in the projection at least one opening (21) is arranged via which the volume of the sleeve (4) is evacuated after insertion of the at least one insert element (3).
